(19) United States
(12) Patent Application Publication
(10) Pub. No.: US 2003/0097730 A1
(43) Pub. Date: May 29, 2003

(54) Heating device, especially for handle of a portable implement

(75) Inventors: Heinrich Leufen, Schwaikheim (DE); Rolf Walter, Waiblingen (DE); Mohamed Abou-Aly, Waiblingen (DE)

Correspondence Address: ROBERT W. BECKER & ASSOCIATES, Suite B, 707 Highway 66 East, Tijeras, NM, 87059, US

(73) Assignee: Andreas Stihl AG & Co, Badstr., Waiblingen (DE)

(21) Appl. No.: 10/292,563

(22) Filed: Nov. 12, 2002

(30) Foreign Application Priority Data
Nov. 26, 2001 (DE) 101 57 912.8

(51) Int. Cl. E05B 1/00

(52) U.S. Cl. 16/110.1

(57) ABSTRACT

A heating device is provided for a handle of a portable implement, especially a chain saw, a brush cutter, trimmer or the like. At least one heating element is disposed in the handle for heating the handle. The heat-conducting element is connected to the heating element and serves for a distribution of heat within the handle and for a transfer of heat to the handle.

### BACKGROUND OF THE INVENTION

The present invention relates to a heating device, especially for a handle of a portable implement, in particular for a power chain saw, a brush cutter, a trimmer, or the like.

Portable, manually-guided implements are known, the handles of which are provided with heating elements, such as heat foils having conducting paths or heating plates, in order to heat the handles. The heating elements are often strip-shaped structures that are poorly adapted to the contour of the respective handle and thus do not reach all of the inner surfaces of the handle. Thus, with these known devices it is not possible to preclude a non uniform transfer of heat from the heating elements nor a localized overheating of the heating elements, which ultimately leads to an inability of the device to function. Furthermore, the heating of the handle is very irregular, so that a noticeable heating effect results only in the immediate vicinity of the heating element, and the remote regions remain essentially cold.

It is therefore an object of the present invention to provide a heating device, especially for a handle of a portable implement, with which it is possible to achieve a uniform, reliable heating.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of a portion of a handle of a portable, motor-driven implement that has an inventive heating device;

FIG. 2 is a perspective view of the heating device of FIG. 1;

FIG. 3 is a view of the heating device taken in the direction of the arrow III in FIG. 2;

FIG. 4 is a side view of the heating device of FIG. 3;

FIG. 5 is a perspective view of a further heating device having a compartment-like, heat-conducting element;

FIG. 6 is a perspective view of a further heating device in the form of a hollow profiled part that is closed on the periphery; and

FIG. 7 is a perspective view of a further heating device.

### SUMMARY OF THE INVENTION

For the uniform supply of heat to a handle of the portable implement, the heating element is connected, preferably laminarly, with a heat-conducting element. The heat of the heating element, which is preferably electrically supplied by a generator or a battery, is transferred during operation of the heating device to the heat-conducting element, and is transferred from the heat-conducting element to the handle convectively, by thermal radiation, or via thermal conduction. It is expedient to permanently hold the heat-conducting element in contact with an inner surface of the handle, as a result of which the supply of heat to the handle is predominantly effected by thermal conductance, while thermal radiation or just convective heat transfer play a lesser role. With implements having a number of handles, it is, of course, to be understood that each of the handles can be heatable. The advantage of the present invention is that a good transfer of heat is also possible over component interfaces.

The heat-conducting element is preferably adapted to the shape of the inner surfaces of the handle in such a way that to the greatest extent its entire surface is fully in contact with the inner surfaces of the handle. Even complex shapes of the handle and peripheral regions of the handle can be reached and heated with an appropriately shaped heat-conducting element. For this purpose, the heat-conducting element is preferably formed as a bending stamped metal part having a good thermal conductivity and/or thermal capacity, and is made, for example, from steel, aluminum, brass, copper or the like. It can also be expedient to form a heat-conducting element that is made of wool or felt of heat-conducting material such as metal or heat-conducting plastic. These materials have a plastically deformable configuration and thereby, when disposed in a handle, adapt particularly well to the respective contour of the inner surfaces of the handle, as a result of which these inner surfaces can be easily and uniformly heated over the entire surface.

Pursuant to a further embodiment, the heating device includes a molded part having a poor thermal conductance, such as plastic, whereby the heat-conducting element is formed by a good heat-conducting layer placed upon the surface of the molded part. The heat-conducting layer can, for example, be a foil of metal or heat-conducting plastic. It can also be expedient to cover or overlay the molded part with a wire grid as a heat-conducting element.

Due to the fact that the heat transfer to the handle is effected with the aid of the heat-conducting element, the spatial extent and the surface area of the heating element itself can be smaller than that of the heat-conducting element to which the heating element transfers its heat. In particular, if there is sufficient installation space in a respective handle, the heating element can be approximately the same size as the heat-conducting element, so that the heating surface of the heating element is the same size as the developed surface of the heat-conducting element.

It is expedient to extend the heat-conducting element to operating elements on the handle. If the heat-conducting element leads to operating elements such as a throttle or a throttle stop, where it is preferably slidingly in contact with the respective control element, the control element can preferably be heated together with the handle via a single heating element. It can also be expedient to dispose a heat-conducting element in the interior of the respective control element, and to connect the heat-conducting element in a control element in a heat-conducting manner, for example via articulations or the like, with the heat-conducting element and/or the heating element in the handle.

The heating element is preferably formed as a foil or plate having an integrated conducting path. It can also be expedient to embody the heating element as a molded part forming an electrical insulator having a heating wire integrated therein. The heating element is preferably positively connected with the heat-conducting element, for example by being riveted or adhesively connected thereto, by being welded thereto, for example in an ultrasonic manner, or in any other suitable manner.

Further specific features of the present invention will be described in detail subsequently.

### DESCRIPTION OF PREFERRED EMBODIMENTS

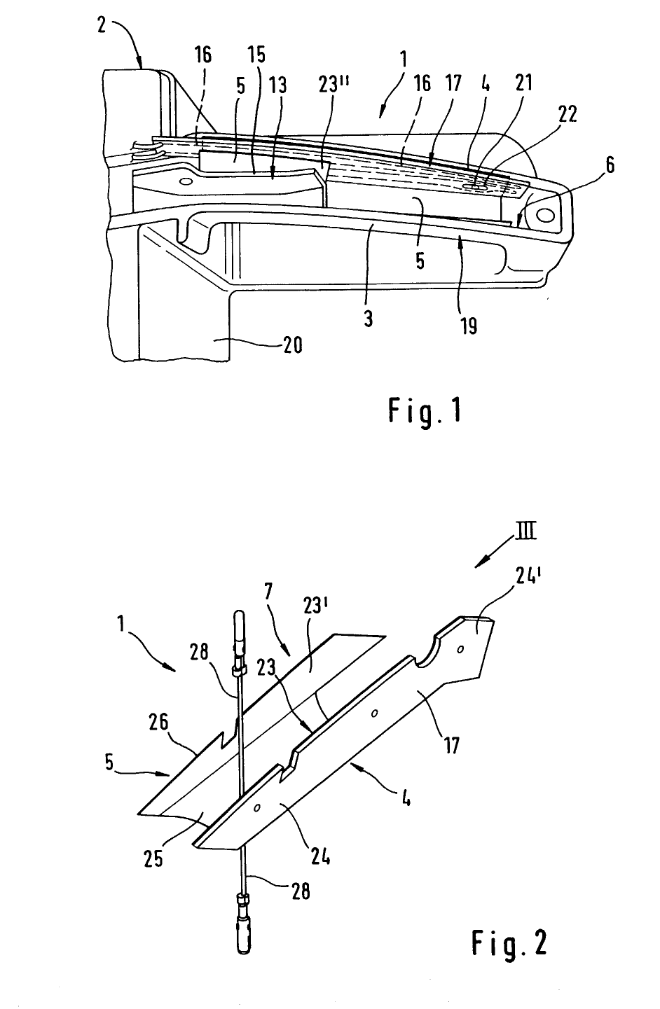

Referring now to the drawings in detail, FIG. 1 shows a perspective view of a portion of a handle 3 of a portable, manually-guided implement 2, such as a power chain saw. The handle 3 is shown as a hollow, two-part component, with the upper side of the handle being removed. The basin or tray-shaped lower portion 19 of the handle serves as a support for control elements 15, of which is shown a throttle stop 15 as an elongated plastic component. To improve the operator comfort of the power chain saw, e.g. when felling or cutting down trees in the winter, a heating device 1 is accommodated in the lower portion 19 of the handle. The heating element 1 is supplied with electricity from a generator of a motor that is accommodated in the housing 20 of the portable implement 2. The heating device 1 comprises a heating element 4 and a heat-conducting element 5 that is laminarly connected with the heating element 4.

In the embodiments illustrated in FIGS. 1 to 5, the heating element is embodied as a planar, flat bar or plate 17 having an integrated conducting path 16 and is positively connected with the heat-conducting element 5 with the aid of flange bolts 21. The bolts 21 project at right angles from the heat-conducting element 5, which is formed as a bending stamped metal part 7, and extends through slots 22 in the heat-conducting element 5, into which slots the bolts are inserted. In this connection, to facilitate servicing and repair, it is expedient to form the heating element 4 as a unit with the heat-conducting element 5, and to removably dispose the unit in the handle. With appropriate adaptation of the shape, it can be sufficient to place the unit in the handle without fastening means, and to require only the electrical contacting. The heating element 4 can, however, also be positively or frictionally connected with the heat-conducting element 5, such as by being adhesively connected or in any other suitable manner.

The heat-conducting element 5 is bent into an approximately U-shaped cross-sectional configuration, with its heating surfaces 23,23′ being shaped in such a way that they rest fully against the inner surface 6 of the handle 3. By means of a partial surface 23″, the heat-conducting element 5 is disposed very close to the throttle stop 15, yet without direct contact therewith, and heats the throttle stop 15. As a result, the heat is transferred very well to the throttle, yet the ease of operation of the throttle is not adversely affected. In this way, further control elements, such as a gas throttle or the like on the handle 3, can be heated by a single heat-conducting element 5 and its partial surfaces. It can also be expedient, with correspondingly complexly shaped handles, or with surfaces that are to be heated that are spaced at a great distance from one another, to provide a plurality of heating devices on a handle. Similarly, for portable, manually-guided implements having two or more handles, each of the handles can be provided with a heating device.

The detailed view of FIG. 2 shows a perspective view of the heating device of FIG. 1. In particular, the heating device 1 is formed of the planar, plate-shaped heating element 4 and the heat-conducting element 5. The heating element 4 includes a plurality of sections 24,24′ that extend in a single plane and form the plate, whereby the shape of the heating element 4 is a adapted to the longitudinal section of the handle 3 in FIG. 1. Fixed fully against the heating element 4 with the aid of two bolts or rivets 21 is the heat-conducting element 5, which is formed as a bending stamped metal part in the form of an aluminum plate.

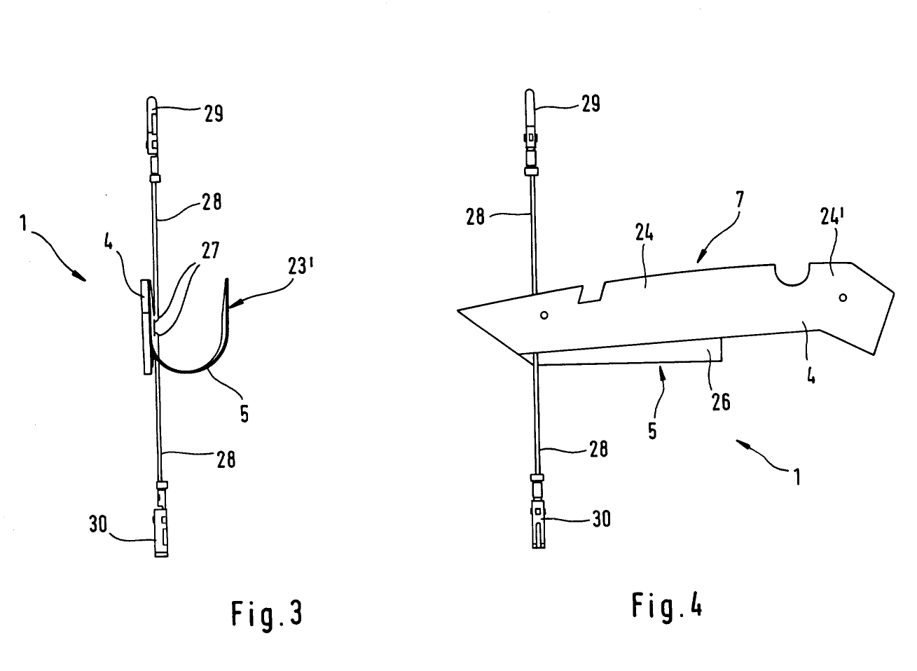

As shown in FIG. 3 in the end view of the heating device taken in the direction of the arrow III of FIG. 2, the heat-conducting element 5 has a U-shaped configuration. In this connection, a bottom portion 25 of the heat-conducting element 5 (see FIG. 2) serves for heating the base of the handle 3. A side portion 26 of the heat-conducting element 5 is disposed across from, spaced from and parallel to the heating element 4, and serves for heating the other side surface of the handle 3.

By means of a switch, the heating device can be selectively turned on or off. As shown in FIGS. 2 to 4, the heating element 4 has two connections 27 at one end of the section 24. At the connections 27, electrical conductors 28 are electrically conductively connected with ends of the integrated conducting path 16 by means of solder connections. The electrical conducting path 16 forms the heating resistance of the heating element and is preferably embodied as a thin metal foil. The conducting path can be applied to the plate or can also be applied to a foil, which is not illustrated, or can be surrounded by some other suitable electrical insulator. The electrical conductors 28 are provided with a plug 29 and a jack 30 for the detachable connection of the heating device to connecting lines of the generator or to some other source of current of the portable, manually-guided implement. The heating device 1 can be disposed in the handle 3 or can be positively fixed in position by connecting elements, which can be detachable. The heating device can also be adhesively secured in the handle, or can be connected to the handle in some other suitable fashion.

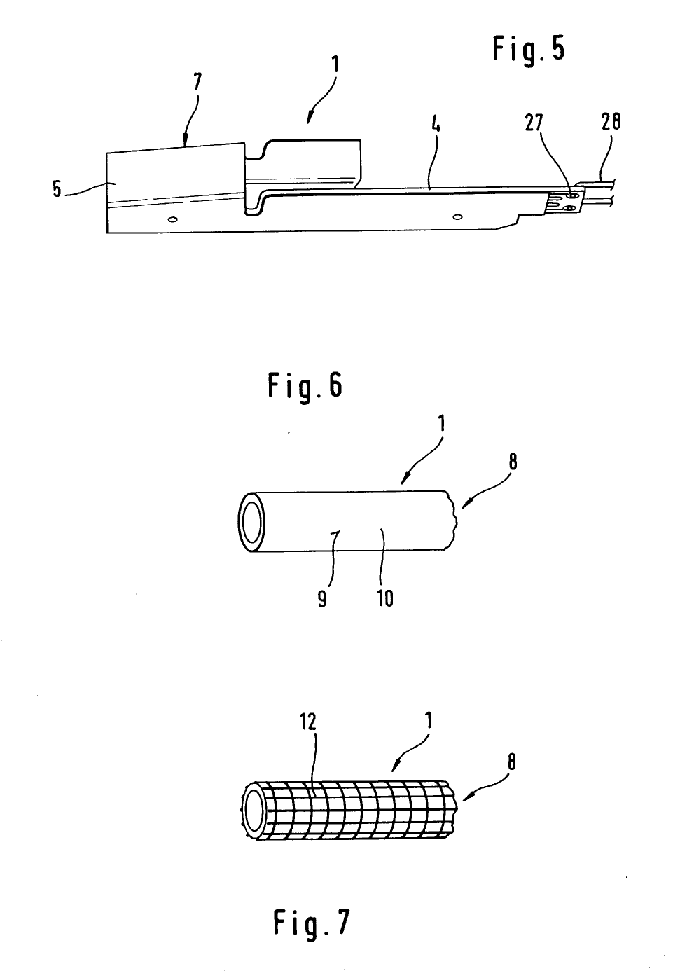

The perspective view in FIG. 5 shows a further heating device 1 where the heat-conducting element 5 is formed as a bending stamped part and has a significantly larger surface than does the heating element 4 itself. The heat-conducting element 5 is formed at one end 24 as a closed compartment having a square or rectangular cross-sectional configuration.

The perspective view of FIG. 6 shows a further embodiment of a heating device 1. This heating device is formed from a heating element which, in the form of a tubular molded part 8, comprises an elastic and electrically insulating material that has a low heat-conducting property. The surface 9 of the molded part 8 is provided with a heat-conducting layer 10 that can be a metal or plastic foil or a heat-conducting coating that is, for example, galvanically applied or spray lacquered on. In this way, the heating device 1 can be easily formed as an extruded part. The molded part 8 is adapted to the contour of a handle, whereby the heat-conducting layer 10 can rest under pressure against the inner surfaces of the handle.

As shown in FIG. 7, it can be expedient to embody the heat-conducting layer 10 as a wire grid 12 on the molded part 8, which is, for example, a plastic tube or hose. Such a wire grid is elastic and flexible, so that it can be easily adapted to the inner contour of the handle and in this manner forms a number of contact surfaces of the heat-conducting element against the handle.

The specification incorporates by reference the disclosure of German priority document 101 57 912.8 filed Nov. 26, 2001.

The present invention is, of course, in no way restricted to the specific disclosure of the specification and drawings, but also encompasses any modifications within the scope of the appended claims.

We claim:

1. A heating device for a handle of an implement, comprising:
at least one heating element disposed in said handle for heating said handle; and
a heat-conducting element that is connected to said heating element and serves for a distribution of heat within said handle and for a transfer of heat to said handle.

2. A heating device according to claim 1, wherein said heat-conducting element is at least partially in direct contact with an inner surface of said handle.

3. A heating device according to claim 2, wherein said heat-conducting element is essentially fully in contact with said inner surface of said handle.

4. A heating device according to claim 1, wherein said heat-conducting element is a bending stamped metal part of steel, aluminum, brass, or copper.

5. A heating device according to claim 1, wherein said heat-conducting element comprises wool or felt and a heat-conducting material.

6. A heating device according to claim 5, wherein said heat-conducting material is metal or a heat-conducting plastic.

7. A heating device according to claim 1, wherein said heating element is a molded part of a poor heat-conducting material, and wherein said heat-conducting element is formed by a heat-conducting layer that is applied to a surface of said molded part.

8. A heating device according to claim 7, wherein said heat-conducting layer is formed by a foil of metal or plastic.

9. A heating device according to claim 7, wherein said heat-conducting layer is a wire grid.

10. A heating device according to claim 1, wherein said heating element has a surface that is approximately the same size as or smaller than a surface of said heat-conducting element.

11. A heating device according to claim 1, wherein said heat-conducting element extends to a control element that is disposed on said handle.

12. A heating device according to claim 1, wherein said heating element is formed by a foil having an integrated conducting path.

13. A heating device according to claim 1, wherein said heating element is in the form of a plate having an integrated conducting path.

14. A heating device according to claim 1, wherein said heating device is positively fixed in position on said handle.

15. A heating device according to claim 14, wherein said heating device is fixed in position on said handle via a detent.

16. A heating device according to claim 14, wherein said heating device is positively connected with said handle by adhesion.

17. A heating device according to claim 1, wherein said heating device is provided with power from a generator or a battery of said implement.
